(19) United States
(12) Patent Application Publication
(10) Pub. No.: US 2006/0165104 A1
(43) Pub. Date: Jul. 27, 2006

(54) Content management interface

(76) Inventor: Elazar Moshe Kaye, Tel Aviv (IL)

Correspondence Address: DARBY & DARBY P.C., P. O. BOX 5257, NEW YORK, NY, 10150-5257, US

(21) Appl. No.: 10/986,488

(22) Filed: Nov. 10, 2004

(51) Int. Cl. H04L 12/56

(52) U.S. Cl. 370/401

(57) ABSTRACT

A platform is provided to respond to data inquiries from callers or users that are directed to one of a plurality of clients or subscribers. A user is guided to a selected client's area on the platform using voice menus and prompts together with speech recognition and database search techniques. The voice prompts are adaptively generated according to the client's policies and the kind of content it offers, and the platform's experience with the user's speech patterns. The content is returned to the caller using a transmission method that is selected in response to voice prompts.

### BACKGROUND OF THE INVENTION

1. Field of the Invention

This invention relates generally to information retrieval systems, and more particularly to a client-directed server system adapted to management of client content for delivery to users, and having a voice interface with telephonic and data networked users thereof.

2. Description of the Related Art

Despite developments in automated data processing, voice inquiries via the public telephone network continue to be extensively used to access and obtain information. In commercial organizations, the sheer volume of callers requires traffic management in order to expedite the transmission of desired information to the caller. Computer databases, and voice processing technology have provided access to information from a wide variety of sources, and have allowed calls to be intelligently and rapidly processed. Today, telephone switches are linked with computers to provide call-handling capabilities. Indeed, voice directed switching is now in common use.

U.S. Patent Application Publication No. 2004/0076275A1 describes a telephonic routing system having mobile wireless and video vending capabilities. A traffic control system provides a video interface among members of buyer groups and vendors via a dial-up telephone system. The system includes a video recording unit for recording and playing video transcriptions, a storage memory for storing data on the members, including telephonic terminal numbers and area-of-interest codes, and a control computer to process data and selectively interconnect the video sources with the remote telephone terminals through the telephonic interface apparatus. The system is intended to be used in a variety of applications, such as directing and exchanging inquiries, offers and responses between members. The system is capable of selectively providing video data for display by an inquiring user terminal.

In U.S. Pat. No. 5,999,525 a telephonic system is disclosed in which multimedia data are routed through a switched network, which includes the Internet. Users can transmit video, audio and data communications of designated quality over the Internet to other registered video telephony users. Network activities are controllable from a central site, while still allowing the operator of the telephone system to maintain quality and routing selection.

Nevertheless, a need remains for a telephonic, wireless, or data network interface system that is optimized for users to conduct a direct conversation with information providers in order to obtain specific information. As yet, no practical system provides a standardized dynamic content interface that bridges the gap between information providers and users by offering direct access to information on mobile, wireless or hand held devices.

### SUMMARY OF THE INVENTION

According to a disclosed embodiment of the invention a platform is provided to respond to data inquiries from callers or users that are directed to one of a plurality of clients or subscribers. A user is guided to a selected client's reserved area on the platform using voice menus and prompts together with speech recognition and database search techniques. The voice prompts are adaptively generated according to the client's policies, the kind of content it offers, and the platform's experience with the user's speech patterns. The client has reserved storage space, which can dynamically be updated with content. The content is returned to the caller using a transmission method that is selected in response to options provided by voice prompts. The transmission options can be automatically selected by the platform, based on the nature of the content or generated according to the client's policy. The client's reserved storage space may act as a standardized interaction connection point to the client's information databases, from which data is delivered in different modes of operation.

Some aspects of the invention provide the user of any voice supported device simple, standardized access and connectivity to client content, using speech recognition. A user simply dials the number assigned to the content management interface processor, speaks a client's name in response to a voice prompt, and verbally chooses content or connectivity in response to the client's main data menu script, the content being available in a selected output mode.

The invention enables companies to economically outsource reception of inquiries and the transmission of multimedia information. The invention differs form known “voice portals” as it offers companies a dynamic content and connectivity management interface, made available in multiple client-managed output modes. It is applicable to wireless, wire-line, and multimodal connectivity sessions between users and clients.

For example, during a session, based on a user's verbal response to a data menu voice prompt placed by the client on its reserved space on the platform, a wireless data session or other multimodal data session is initiated by a content return module.

Alternatively, a connectivity message, such as a URL notification or tag, may be sent to the user's communications device. Once the user accesses the URL within the message, a wireless data session is initiated, connecting the user to the client's web site or internal database server.

Various actionable alerts such as voice, audio, SMS, MMS, WAP push, wireless, wire-line data link, and email may be used to initiate a wireless or wire-line data session. Alternatively, the session may be initiated directly by a user, without an actionable alert, once the user ends the voice interaction with the client's space by verbally choosing a data menu. The platform then initiates the data session.

Alternatively, following a user's verbal response to a data menu voice prompt placed by the client on its reserved space, the user's network operator is sent a data menu connectivity message by the platform, containing chosen connectivity content. A data session is initiated with the user's communications device, connecting the user to the client's web site, database server or to the client's reserved space, in accordance with the connectivity message.

One aspect of the invention provides an ability of a client to offer direct, standardized access to the client's internal databases, either web servers or data servers, in a wireless (or wire-line) data browsing session mode or multimodal mode. This capability is independent of the user's device features and its employed network. A user simply dials an assigned telephone number assigned to a content management interface of a client, speaks a client's name or identifier, and navigates among data menus and submenus, resulting in initiation of a session. Standardized and simplified access to Internet web sites, databases and data networks are thereby provided in the selected data session mode.

Another significant benefit of the invention is the ability of a user to easily gain direct access to relevant and specific data sites in a wireless or wire-line session, using a hand-held device, without having to navigate multiple menus or enter a string of characters on the device. Ease of operation also benefits the client, who prefers that users access information directly in a standardized way.

Multimodal access via the platform enables wireless or wired phone users of next generation networks, such as GPRS, DECT and 3G, 4G, to interact with a wireless or wire-line application or mode in a variety of ways: input with speech, a keyboard, keypad, mouse and/or stylus; and output as synthesized speech, audio, plain text, data display, motion video and/or graphics. Each of these modalities may be used independently or concurrently. Thus, using the facility of the platform, users are able to simultaneously or independently speak, type, hear and see client-supplied information on their mobile devices.

For example, independent multimodality enables wireless device users to seamlessly transition among text, graphic, data and speech modes, depending on their preferences, to interact with data application. Simultaneous multimodality allows speech and data interaction in a single session. Thus a user can initiate a wireless or wired data session and use speech responses and commands, concurrently during the session. The multimodal wireless or wire-line session is initiated according to the user's device and network features, and is agnostic to air and wired interfaces.

A client subscribing to the platform can adapt its content and applications for multimodal access. The client can also offer multimodal connectivity to its internal databases. The platform provides the client with needed protocols and technologies to adapt its content.

For example, using digital TV connectivity, following a user response to a data menu voice prompt, a digital TV operator is sent a data menu connectivity message by the platform. Once the digital TV operator processes the message, a digital television data session is initiated, presenting or connecting the user on its TV terminal to content from the client's web site or internal database server. Establishment of the session is otherwise similar to the sessions described above. The initiated digital television data session may involve multiple digital TV outputs, e.g., a simple data message, voice message, or may require opening an interactive digital TV data and voice channel, or may initiate a live or recorded TV broadcast, according to the client's policy. The opened channel can be adaptive, for example varying its buffer size, or rate of information transmission. The channel is opened when required by a user. A user may be connected to multiple clients on the same open channel using the platform's facilities.

In any case, no content is sent to the users unless they access the platform and select desired information. Thus, the invention differs from push technologies, such as short messaging service (SMS), in which content is generally distributed to a predetermined group of mobile phone users.

The content management interface processor and a session analysis module contained therein play an important role in ensuring the smooth and adequate operation of the user-system-client interaction session, including user-system interaction, user-client interaction, content selection, selection of transmission methods, and content return. All necessary actions, including interventions in user sessions, may be undertaken by the content management interface processor, which can override client and user policies in order to ensure smooth and accurate user-system-client interaction. For example, the content management interface processor may alter or add to a client's voice prompt or vocal presentation script if necessary to assist in the completion of the user-system-client interaction session. The content management interface processor may adaptively customize voice prompts, adding features, e.g., leading questions, requests for additional information, rephrasing, repeating, confirmations or similar inquiries, all or which can be added to user-system-client dialog scripts or data menus.

The invention provides a computer-implemented method of information retrieval, which is carried out by subscribing a plurality of clients to a common server, and for each of the clients, defining a memory for content thereof, and monitoring changes in the content in the memory. Responsively to the changes, first voice menus are automatically generated, directing a user to the content of one of the clients for selection thereof. Second voice menus are automatically generated that prompt the user to vocally select transmission methods for delivery of selected portions of the content to the user, wherein vocal responses of the user to the first voice menus and the second voice menus are automatically recognized by the server. The method is further carried out by initiating delivery of the selected portions of the content to the user via selected ones of the transmission methods.

An aspect of the computer-implemented method includes selecting a connectivity method for transmission or display of the selected portions of the content to the user.

According to another aspect of the computer-implemented method, the user accesses the server using a voice supporting communications device.

According to further aspects of the computer-implemented method, the memory can be located in the server, or can include a database at a location that is remote from the server.

One aspect of the computer-implemented method includes limiting a number of connections between at least a portion of the clients and concurrent users that are accessing the server.

An additional aspect of the computer-implemented method includes limiting the amount of the content that is available to the user.

A further aspect of the computer-implemented method includes uploading user data from the user via selected transmission methods and selected connectivity methods for storage thereof in the memory of at least a portion of the clients.

The invention provides an information management system, including a common server operative to perform the steps of subscribing a plurality of clients thereto, and for each of the clients, defining a memory for content thereof, and monitoring changes in the content in the memory. Responsively to the changes, first voice menus are automatically generated, directing a user to the content of one of the clients for selection thereof. Second voice menus are automatically generated by the server that prompt the user to vocally select transmission methods for delivery of selected portions of the content to the user, wherein vocal responses of the user to the first voice menus and the second voice menus are automatically recognized by the server. The server is operative to initiate delivery of the selected portions of the content to the user via selected ones of the transmission methods.

According to one aspect of the information management system, the server is operative to provide a plurality of connectivity methods that are selectable by the user for transmission of the selected portions of the content to the user.

According to still another aspect of the information management system, the server is operative to provide a plurality of connectivity methods that are selectable by the clients for transmission of the selected portions of the content to the user.

According to another aspect of the information management system, the server is operative to assign a content management interface to each of the clients for interaction therewith.

The invention provides a computer software product, including a computer-readable medium in which computer program instructions are stored, which instructions, when read by a computer, cause the computer to perform a method of information retrieval, which is carried out by subscribing a plurality of clients to a common server, and for each of the clients, defining a memory for content thereof, and monitoring changes in the content in the memory. Responsively to the changes, first voice menus are automatically generated, directing a user to the content of one of the clients for selection thereof. Second voice menus are automatically generated that prompt the user to vocally select transmission methods for delivery of selected portions of the content to the user, wherein vocal responses of the user to the first voice menus and the second voice menus are automatically recognized by the server. The method is further carried out by initiating delivery of the selected portions of the content to the user via selected ones of the transmission methods.

The invention provides a computer-implemented method of information retrieval, which is carried out by subscribing a plurality of clients to a common server, establishing a voice channel between the server and a user. The method further comprises, using the server, presenting first voice menus to the user on the channel that prompt the user to specify one of the clients, interpreting a first vocal answer from the user responsively to the first voice menus so as to identify the one client, presenting second voice menus to the user on the channel that prompt the user to specify data of the one client, interpreting a second vocal answer from the user responsively to the second voice menus so as to identify the data, presenting third voice menus to the user on the channel that prompt the user to specify a mode of transmission of the data to the user, interpreting a third vocal answer from the user responsively to the third voice menus so as to identify the mode of transmission, and causing a transfer of the data to the user via the mode of transmission.

An additional aspect of the computer-implemented method includes the step presenting fourth voice menus to the user to specify a connectivity method for the transfer or display of the data.

According to one aspect of the computer-implemented method, at least one of the first voice menus, the second voice menus and the third voice menus are adaptively generated by the server responsively to vocal answers of the user.

The invention provides a computer software product, including a computer-readable medium in which computer program instructions are stored, which instructions, when read by a computer, cause the computer to perform a method for information retrieval, which is carried out by subscribing a plurality of clients to a common server, establishing a voice channel between the server and a user. The method further comprises, using the server, presenting first voice menus to the user on the channel that prompt the user to specify one of the clients, interpreting a first vocal answer from the user responsively to the first voice menus so as to identify the one client, presenting second voice menus to the user on the channel that prompt the user to specify data of the one client, interpreting a second vocal answer from the user responsively to the second voice menus so as to identify the data, presenting third voice menus to the user on the channel that prompt the user to specify a mode of transmission of the data to the user, interpreting a third vocal answer from the user responsively to the third voice menus so as to identify the mode of transmission, and causing a transfer of the data to the user via the mode of transmission.

The invention provides an information management system, including a common server operative to perform the steps of subscribing a plurality of clients thereto, establishing a telephonic voice channel between the server and a user, presenting first voice menus to the user on the channel that prompt the user to specify one of the clients, interpreting a first vocal answer from the user responsively to the first voice menus so as to identify the one client, presenting second voice menus to the user on the channel that prompt the user to specify data of the one client, interpreting a second vocal answer from the user responsively to the second voice menus so as to identify the data, presenting third voice menus to the user on the channel that prompt the user to specify a mode of transmission of the data to the user, interpreting a third vocal answer from the user responsively to the third voice menus so as to identify the mode of transmission, and causing a transfer of the data to the user via the mode of transmission.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a content management system, which is constructed and operative in accordance with a disclosed embodiment of the invention;

FIG. 2 is a flow diagram illustrating a method of obtaining information using a content management interface in accordance with a disclosed embodiment of the invention;

FIG. 3 is a flow diagram describing a method of client subscription to a content management interface platform in accordance with a disclosed embodiment of the invention; and

FIG. 4 is a functional table of a content management interface platform in accordance with a disclosed embodiment of the invention in which maximum services are provided by a content management interface platform.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications or data network, such as the Internet. In addition, while the invention may be embodied in computer software, the functions necessary to implement the invention may alternatively be embodied in part or in whole using hardware components such as application-specific integrated circuits or other hardware, or some combination of hardware components and software. Definitions.

The terms “client space”, “client's memory store”, “client's content memory store” and “client's reserved space” refer to facilities of a content management interface processor that are reserved for use by a particular client, e.g., memory storage, content store, content management interface, or a reserved communications channel.

Terms including “verbally”, “say”, “user selects”, “selected”, “chosen”, “user requires”, “user prefers”, “voice commands”, and “user response” refer to speech recognition and voice generation functions within a content management interface processor.

The term “wireless phone/network” has the same meaning as cellular, mobile, cordless or satellite telephone network.

The term “wireless data session” means the ability of a cellular, mobile, wireless, contactless or cordless phone, telephone, terminal, appliance, device and hand held device or network to display, support and enable a data session or a visual data session, such as an internet data session, a multimedia session or a messaging session. The term “wireless data session” additionally includes the ability of a wire-line, fixed wireless or satellite devices and networks to support, enable and display a data session, such as IP or ISDN devices or cordless phones.

A wire-line data session is the ability of a wired line or fixed line based device to support, enable and display data, such as SMS, MMS, internet, email, video and messaging data sessions and other data based features.

The term “multimodal” refers to technology that allows users of wireless, wired, or data phones, and any suitable devices, appliances and networks to take advantage of multiple channels simultaneously or independently, and interact with applications or content through voice, speech, and conventional input modes, such as a keyboard in response to a dialog box or visualized data screen.

System Overview.

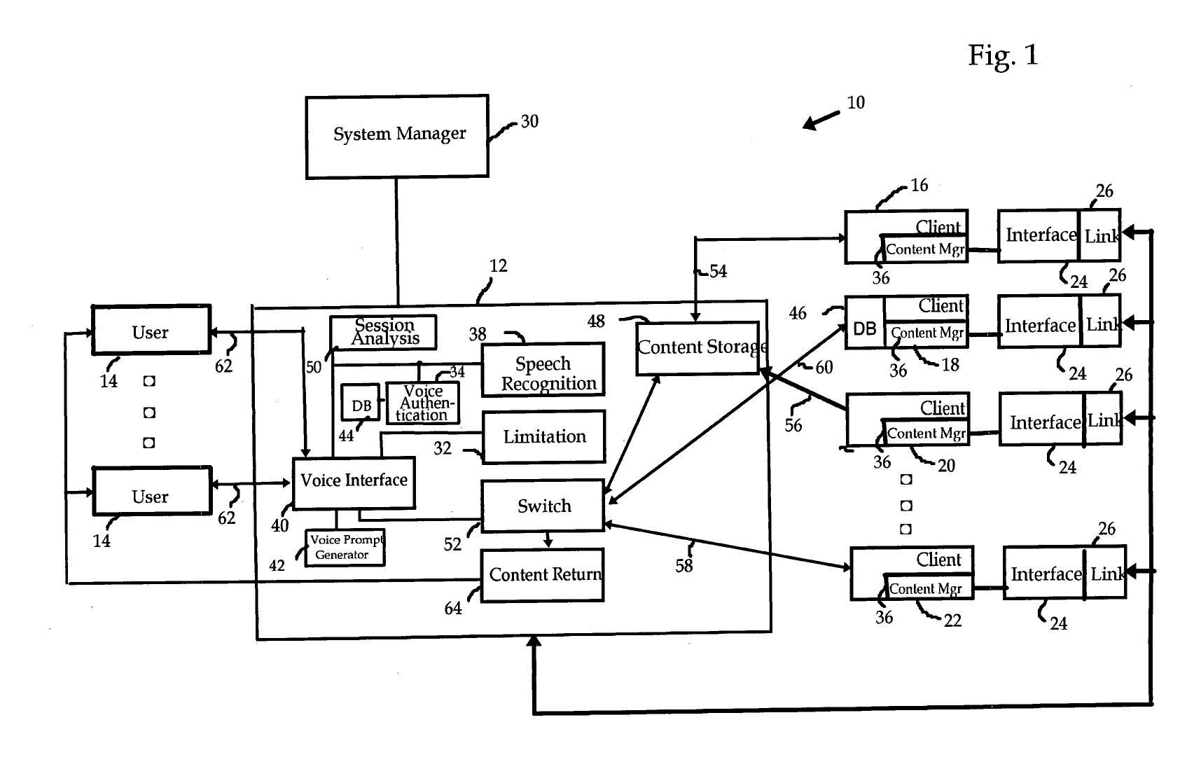

Turning now to the drawings, reference is initially made to FIG. 1, which is a block diagram of a content management system 10 that is constructed and operative in accordance with a disclosed embodiment of the invention. At the heart of the system is a content management interface processor 12, which is accessed by users 14 seeking information. The link between the content management interface processor 12 and the users 14 typically involves voice transmission or voice communication over a public telephone, wired, mobile, wireless or data networks. The devices employed by the users 14 could be conventional telephones, wireless devices, such as cellular telephones, computers, PDA's or any combination. Indeed, any device capable of supporting a voice channel may be used to establish a link to the content management interface processor 12. A plurality of clients, shown representatively as clients 16, 18, 20, 22 provide a distinct content management interface 24 for each client with the users 14 that operates via assigned links 26 leading through the content management interface processor 12. The content management interface 24 and reserved space can be implemented as a standalone application by a client. The system 10 is capable of concurrently supporting a plurality of users, each of whom may be interested in different ones of the clients 16, 18, 20, 22.

Administrative functions for the system 10 are provided by a system manager 30, which is typically an executing software program in a computer or server that includes other elements in the system 10, in particular the content management interface processor 12. The system manager 30 conducts monitoring, reporting, testing and various other actions necessary for system operation. A system manager 30 has access to such memory areas in the system 10 as are required for maintenance, debugging, and updating. The system manager 30 has exclusive supervisory privileges as to operational aspects of the system 10.

The content management interface processor 12 provides a limitation module 32, which limits access to clients in accordance with a governing policy. For example, the content management interface processor 12 can be configured to limit the number of concurrent users accessing a particular client, or enforce a cap on the total number of users accessing the content management interface processor 12 at one time. Additionally or alternatively, the limitation could enforce the use of user voice verification or a password by using a voice authentication module 34, and could be triggered by one or more modes of access by the users 14. A voice limiting prompt is generated automatically by the content management interface processor 12, and attached to a client's data menu script that is presented to the users 14 by the content management interface processor 12 as a dialog scenario. All users on the platform may be monitored by the system manager 30. Thus, each time a caller enters a client's space the content management interface processor 12 records the entry and notifies the system manager 30. The limitation module 32 is an optional service, which must be elected by the client via its content management interface 24. If not elected, it will not be available to a content manager 36 during configuration or routine operation, nor will it be invoked by the system manager 30. Connectivity is optional as well. Various connectivity configurations are disclosed in further detail hereinbelow.

The content management interface processor 12 is based on speech recognition technology, which enables searches, responses, queries, interactions or dialogue scripts driven by human voice—the most natural interface for a human user. The user-system-client interaction session is based on speech recognition. A speech recognition module 38 supports a voice interface 40 to the users 14. The content management interface processor 12 also includes a voice prompt generator 42. Speech (or lip) recognition products from any of the following vendors are suitable for use in the speech recognition module 38, the voice authentication module 34, and the voice prompt generator 42 in many combinations: Phonetic Systems, 300 Concord Road, 5th Floor, Billerica, Mass. 01821;. ScanSoft, Inc. 9 Centennial Drive, Peabody, Mass. 01960; and Nuance, 1005 Hamilton Court, Menlo Park, Calif. 94025. The content management interface processor 12 could also be based on Distributed Speech Recognition vendors such as Conversay, Inc., 15375 NE 90th Street, Redmond, Wash. 98052, or on handset based speech recognition vendors such as Advanced Recognition Technologies, Ltd, 3375 Cochran St., Simi Valley, Calif. 93063. Multimodal products are available from vendors such as V-Enable, Inc., 4250 Executive Square Drive, Suite 200, La Jolla, Calif. 92037, LogicTree Corporation, 8400 Baltimore Ave., Suite 301, College Park, Md. 20740. Voice speaker verification and authentication systems are available form Persay Inc, 30 West 21st Street, 10th Floor, New York, N.Y. 10010.

The speech recognition module 38 has voice-to-text capabilities. Suitable voice to text products are available from ScanSoft, Inc. 9 Centennial Drive, Peabody, Mass. 01960 (Dragon NaturallySpeaking family), and One Voice Technologies, Inc., 6333 Greenwich Drive, Suite 240, San Diego, Calif. 92122 USA. The Active Prompts™ text-to-speech product, available from Rhetorical Systems Ltd., 4 Crichton's Close, Edinburgh EH8 8DT, United Kingdom or the SpeechWorks™ text-to-speech products, available from Scansoft, Inc., 9 Centennial Drive Peabody, Mass. 01960 are also suitable for the text-to-speech software. Dialog scripts, vocal interactions and data menu prompts are saved as voice files or other digital forms on the content management interface processor 12, which, as noted above, loads and associates data menu prompts with content and selections, as determined by the content manager 36.

Data needed for the user-system-client interaction sessions, including data menus and submenus, voice prompts, vocal presentations, dialogue scripts, connectivity content addresses or data, client identifiers and user created content messages are stored on a database 44, which is linked to the voice interface 40. All vocal presentations including, voice prompts representing data menus and data submenus, vocal interactions, connectivity content and addresses, transmission method prompts, user interaction prompts or any other user-system-client session dialog script, and data needed to complete the session, whether client-created or system-related, are also stored and expressed in the database 44. This is done for quality assurance purposes and for supporting clients configured like the client 18, which utilize internal content stores, such as the database 46. Some data may also be held in a client's reserved space in a memory store 48, also referred to herein as a content store. The voice interface 40 is supported in the background by a conventional DTMF based touch-tone keypad IVR application.

All the benefits of the above-noted speech recognition products may be advantageously employed by the speech recognition module 38. For example, if a user has a specific data query, “barge-in” capability will enable the user to override all data menu voice prompts and reach the desired content. The voice interface 40 is able to record user data inquires and process them offline, so that costly airtime usage is saved.

The speech recognition module 38 is cooperative with a session analysis module 50, the voice authentication module 34 and the database 44, to analyze a current session and detect exceptional situations that may require intervention in the session by the content management interface processor 12. In such sessions, the users 14 may access the client's reserved space in the memory store 48, for example, using DTMF, only with the authorization of the system manager 30 and the session analysis module 50.

The voice interface 40 is linked to a switch 52, which establishes one of the several possible channels 54, 56, 58, 60 for bi-directional transmission of information in a transaction that was initiated by one of the users 14 with one of the clients 16, 18, 20, 22. The nature of the channel depends upon the configuration of the particular client with the content management interface processor 12. For example, in the case of the client 22, the channel 58 would be a simple voice channel. If the transaction involved the client 18, the channel 56 would be appropriate for data transmission between the content management interface processor 12 and the database 46. Access to the database 46, which is the content store of the client 18, may be mediated by a voice extensible markup language (VXML) application with a direct data link. In the case of the client 16, which has delegated the most responsibility to the content management interface processor 12, the channel 54 would extend only to the content memory store 48. The memory store 48 is under control of the content management interface processor 12 and the system manager 30. The transaction would impose no burden upon the client 16 whatsoever, regardless of whether the client database 46 is linked, via the channel 60, to the reserved memory store 48, or whether the client 18 does not use the memory store 48, but connects directly to the switch 52.

Each of the clients 16, 18, 20, 22 has its own content manager 36, which interacts with the content management interface processor 12 via the client's content management interface 24. In some embodiments, the content manager 36 may be a human operator. The content manager 36 is responsible for configuration, and otherwise specified, is the exclusive means for interaction with the content management interface processor 12. For example, a client can associate different content with different transmission methods on the same data menu. Alternatively, different data menus can be associated with different transmission methods. Transmission method and connectivity options selections, platform service, step selections and configurations may be updated and changed by the client according to the client's policy. The content manager 36 is guided by its assigned content management interface 24 in selecting these options.

Any configuration, selection or change occurring on the client's content management interface 24 is expressed in the content management interface processor 12, or in the client's content store. It will be recalled that the client's content can be either the client's reserved space on the memory store 48, or the internal database 46. Additionally, such changes may be reflected in other memory areas (not shown) within the content management interface processor 12 that relate to the particular client. The client's reserved space may provide interconnections to other internal databases. For example, once a user has navigated into a client's space on the system 10 he may then be redirected to one of these other internal databases.

The links 26 connecting each content management interface 24 to the content management interface processor 12 are bi-directional, allowing the content management interface processor 12 to control and operate the content management interface 24.

The content management interface processor 12 is also responsible for all interactions involving the users 14, the content management interface processor 12, and the clients 16, 18, 20, 22. These interactions include adaptive voice prompt generation and allocation at relevant user-system and user-client sessions, addition, storage, and conversion of content, returning of content to the users 14, client configuration, transmission method and connectivity selection and verification, speech recognition, user-system-client dialogue scripting, linking of the various assigned clients content management interfaces to users, channel allocation, session analysis, and the placing of limitation on content. These and other functions of the content management interface processor 12 are detailed hereinbelow.

The users 14 relate to the system 10 by links 62 to the content management interface processor 12. Any device capable of supporting voice or a voice channel may be used to establish the links 62. The link typically involves voice transmission or communication for the initiation of the user-system-client session and for enabling the speech recognition module 38. Wired telephones, cordless phones, digital phones, wireless devices, portable and mobile devices, cellular phones, computers and computer phones, satellite devices, appliances, electronic devices, hand held devices, PDA's and the like, may be employed by the user to access the system 10. Any wire-line, wireless, fixed wireless, cellular, data, satellite or wireless broadband technologies and networks may support the links 62, including voice over IP, and dual mode (data and voice) or single mode networks and devices.

The client 16 uses the memory store 48, to which it is linked by the channel 54. Content that the client 16 desires to provide to the users 14 is stored therein, and is accessible to the users 14. Responsibility for technical management of the data in the memory store 48 is largely assigned to the system manager 30. This function is disclosed in further detail hereinbelow. The system 10 determines the method of providing selected information to the users 14, in accordance with general policies set by the client 16 and the implementation of the policies by the system manager 30.

The client 18 does not use the memory store 48. Instead, in one configuration, it has an internal database 46 or content store, which is directly linked to the content management interface processor 12 via the channel 56, indicated by a broken line. Content to be provided to the users 14 is drawn directly from the database 46. The client 18 assumes responsibility for the management of the database 46 and the organization of information that it wishes to provide to the users 14. However, the system manager 30 and content management interface processor 12 may play a role in determining the manner in which selected information is returned to the users 14.

Alternatively, as indicated by the configuration of the client 18, the memory store 48 may be directly linked to an internal client database or web site via the channel 60. Modifications in the internal database will automatically appear on the memory store 48 as defined by the client, thereby avoiding the need to manually update the memory store 48. This alternative allows the users 14 to interact transparently with the client 18 using the content management interface processor 12.

The client 22 is connected directly to the content management interface processor 12 via the channel 58, which redirects calls to the client 22, typically to human operators. No data management functions are otherwise provided by the system 10. The system manager 30 has no responsibility for returning information to the users 14. Instead, this role is assumed by the client 22. Optionally, the client 22 may offer content and connectivity at the end of, or during of a user session by default, or according to pre-set criteria by utilizing the memory store 48.

The client 20 uses the memory store 48 by configuration of its content management interface 24, to which it is linked by the channel 56. Connectivity content or data relating to a connectivity mode, which the client 20 desires to provide to the users 14, is stored therein as a data menu voice prompt script, and is accessible to the users 14. The channel 56, the content management interface processor 12, and a content return module 64 connect and present the users 14 to a user selected data menu voice prompt content area on the client's internet web server or to a client's internal database server, thus initiating a wireless data session or a wire-line data session. This session may be any suitable communications protocol, browsing session, format or layout for example: WAP data browsing session, HTML and its extensions, such as, WXHTML, CHTML, IHTML and XHTML; i-mode and m-MODE data browsing sessions. The wireless or wire-line data session is initiated according to the user's device and network features and is agnostic to air or wired interfaces. For example, the session may be conducted across many known networks, including data and voice networks, wireless or wire-line device platforms, employing various protocols and operating systems. More specifically the session can be conducted using known platforms, e.g., Java™, BREW™, Palm™, Symbian, and Smartphone™. The client 20 can be configured with additional connectivity modes in like manner, including multimodal wireless or wire-line data session connectivity and digital TV data session connectivity.

Content is returned or connected to the users 14 by the content return module 64, which is linked to the clients 16, 18, 20, 22 and to the memory store 48 via the channel established by the switch 52. Whether a client utilizes the system's content memory store 48 or its internal content store, e.g., the database 46, the content return module 64 returns the content or establishes a connection to the users 14. Data or content transmission methods and connectivity options between the content management interface processor 12 and the users 14 may vary widely, depending upon the choices made by the users 14 and the governing policies of the clients 16, 18, 20, 22 and those of the content management interface processor 12. These governing policies are expressed in the data menu voice dialog scenarios and scripts presented to the users 14. Transmission methods may, for example, involve any one or combinations of voice, voicemail, audio, email, mobile email, email attachments, facsimile, short messaging service (SMS), text messaging, multimedia messaging service (MMS), multimedia content cards and servers, enhanced messaging system (EMS) or electronic mail system, video and streaming video, wireless or wire-line data sessions, data download session, digital or broadcast or interactive television terminal data sessions, computer data session, http documents, with or without embedded Java scripts, Java applications, e.g., J2ME™, BREW, Multimodal session, iMode, smart posters, instant messaging, and Personal Information Management (PIM). Virtually any technology for sending, enabling and supporting data and information to various communication devices and electronic devices, including pictures, documents, sound and images, may be employed by the content return module 64 by invoking appropriate facilities of the speech recognition module 38. Indeed, the content return module 64 may be capable of automatically submitting printed content to the postal service or to a telegraph company.

User Operation.

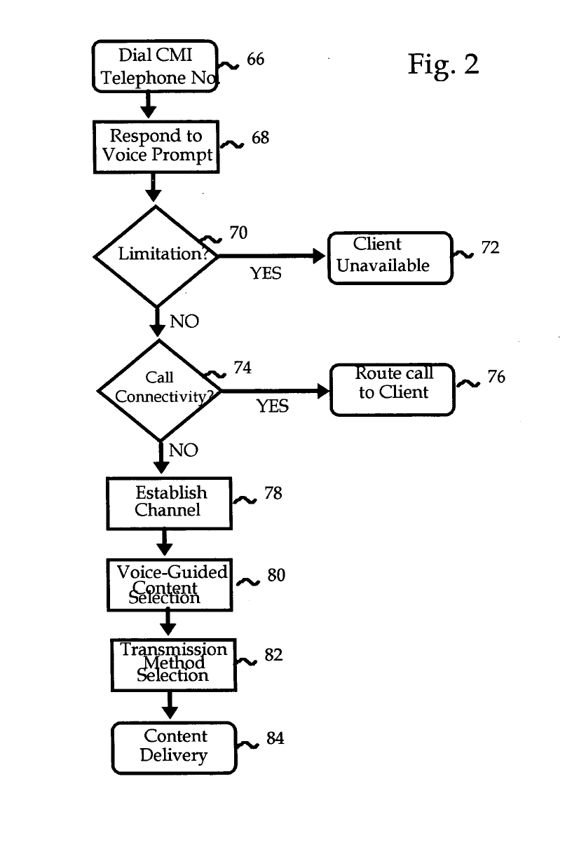

Continuing to refer to FIG. 1, the method by which the users 14 obtain desired information is now described. Reference is made to FIG. 2, which is a flow diagram illustrating a method of obtaining information using a content management interface in accordance with a disclosed embodiment of the invention.

The process begins at initial step 66. A user desiring to obtain information or to initiate a connectivity option dials a telephone number that is assigned to the content management interface processor 12, using any suitable voice supporting communication device. Typically, the user is an individual. However, the content management interface processor 12 is also capable of supporting automated queries generated by computers.

Next, at step 68 a telephone or data connection between the user and the content management interface processor 12 is established. The connection is established according to the user's device and network features. The content management interface processor 12 is linked to mobile, wireless, fixed wireless, wired and data operators, carriers, networks and service providers via available and offered configurations, e.g., ISDN, T1, T3, IP, so to enable users to access the system 10. A voice prompt offered by the system 10 invites the user to express the name of the client of the content management interface processor 12, whom he wishes to access. The client may be any personal, institutional, commercial or noncommercial subscriber. The client could even be identified by a trademark, servicemark, product model, application, utility, function or other designation, according to the client's policy. In one embodiment, the client and the user may be the same entity. The user may be asked to disclose details of his communication device. The user's response may influence subsequent voice prompts occurring in the session, including voice prompts dealing with return of selected content. The responses of the user are acknowledged, using the speech recognition capabilities of the content management interface processor 12.

Identifiers of clients subscribing to the system 10 are included in a database of the content management interface processor 12, which is searched automatically upon recognition of the user's response to the voice prompt. Should the user mispronounce a client name, another voice prompt requests that the user restate it, or may ask a leading question, e.g., “Did you mean ABC?”. Once the user confirms, he is routed to the client's reserved space. Additional data menu voice prompts asking leading questions appear when needed throughout the session. The voice prompts can be programmed to differentiate among corporate subsidiaries, branches, different activities, or product lines of a client if appropriate. Each differentiated entity may subscribe to a separate space, reachable via various paths.

The database 44 may be configured by the client and system manager 30 to be able to react to a variety of user responses regarding client names, once a response is identified with a certain defined client, the user will be routed to the client's reserved space. In one embodiment, a list of clients may be presented to the user in accordance with the user's response. Clients included in a client list may be presented randomly or systematically.

Alternatively, a user may send the system 10 a digital or electronic message specifying the client name, required content and preferred transmission mode, the content management interface processor 12 processes the message and establishes the required channel and content delivery method.

Alternatively or additionally, a user may access the content management interface processor 12 by initiating a Multimodal, BREW or Java application or other applications, technologies and systems configured with the system 10 from or on his device. The configured application may be initiated by the user by launching the suitably configured application on the user's device, or by dialing the telephone number that is assigned to the content management interface processor 12 or dialing the telephone number assigned to a content management interface of a client, at which time the application is initiated according to the user's device features and network capabilities. For example, once a multimodal application is initiated, the user can employ either speech commands or the data keypads.

Next, at decision step 70 a determination is made whether a limitation policy is applicable to the current user with respect to the designated client. Such a policy might relate, for example, to the mode of access by the user, the number of concurrent users accessing the client, or such user characteristics as language or geographic location, or even a blocking request by a client as to the particular user or class of users.

If the determination at decision step 70 is affirmative, then control proceeds to final step 72. The current user is informed by a voice prompt that the client he wishes to access is not available. The procedure terminates.

If the determination at decision step 70 is negative, then control proceeds to decision step 74, where a determination is made whether the client designated by the current user has elected the call connectivity option in option as described hereinbelow. This is the case for the client 22 (FIG. 1). If appropriately configured, the clients 16, 18 can also offer the connectivity option at any time after a user has entered the client's space.

If the determination at decision step 74 is affirmative, then control proceeds to final step 76. The user is routed to the telephone number on record at the content management interface processor 12. While involvement of the content management interface processor 12 is relatively limited for clients, which have elected only the call connectivity option, it nevertheless monitors the user's search pattern, and logs instances when the user fails to obtain content after a predetermined time interval or in accordance with other criteria. In such cases, an appropriate connectivity voice prompt is announced to the user by the content management interface processor 12.

In general, once the content management interface processor 12 by the session analysis module 50 has identified a difficult user, for example a user struggling to reach a client or navigate in a client's reserved space, it intervenes to help complete the user-system-client interaction session. For example, alternatives may be offered, such as the client 22 connectivity option, if available. The content management interface processor 12 may also connect the user to a call center (not shown) associated with the system 10, for completion of the session according to preset criteria. For example, a live call center agent could initiate a wireless data session or send a MMS message from a client's space, if required by the user. Alternatively, the session analysis module 50 may activate a DTMF touch-tone keypad application to complete a user input inquiry. The database 44 associated with the voice interface 40, is equipped with a voice recording module, which records user data inquiry sessions with the system 10 and a client. Using this facility, the content management interface processor 12 may perform “offline” speech recognition processing and completion of user voice inquires. Alternatively, the content management interface processor 12 may deliver the content in the most generic way. For example, if MMS was chosen by the user, but the message fails, or the user's device does not support the chosen transmission method, the content management interface processor 12 may send the content using SMS, or employ a voice file. The transmission mode selection may also be based on stored data relating to the user on the voice authentication module 34. The content management interface processor 12 also monitors the communication device used by the user during navigation. In the event of a failed transmission, the content management interface processor 12 may automatically communicate with the user at a later time, in order to deliver the requested content, or may automatically send the content using a more generic method. An appropriate alternative voice prompt is announced to the user by the content management interface processor 12 indicating the action to be taken.

Optionally, the content management interface processor 12 may override preset criteria when it detects an exceptional situation, for example a “difficult” customer. This is accomplished by use of the speech recognition module 38 and known artificial intelligence methods that are executed by the session analysis module 50 to identify exceptional characteristics of the current session. Identification of such exceptions may optionally be registered in the limitation module 32, which would then be operative to exclude such users from the client in the future. Additionally or alternatively, the content management interface processor 12 may intervene in the session to limit or terminate it.

If the determination at decision step 74 is negative, then control proceeds to step 78. A channel is established between the current user and the client's content store in accordance with the client's configuration in the content management interface processor 12. As noted above, the channel could enable access to the memory store 48 in the content management interface processor 12, or to a linked database at a remote client site, such as the database 46. The user is greeted with the client's entrance voice prompt.

In some embodiments step 78 is performed prior to decision step 74. The order may be determined by the client. Thus, the client determines if a user is channeled to the content store and then offered call connectivity, or vice versa.

Next, at step 80, via the channel established in step 78, the current user is routed to the client's data menu sequence voice prompt, which may be a main data menu script. This is a client-created dialog script used to interact with users entering the client's space. It is stored on the database 44 and on the client's content store. It is typically created by the content manager 36 using the content management interface 24 of the particular client. Responsively to this voice prompt, the current user then selects desired content. This is accomplished using conventional speech recognition software in the speech recognition module 38. The speech recognition module 38 operates by reviewing the speech utterances and patterns of the current user, followed by searches against a content management interface database to match the user's responses to the data menu prompt with content on the client's content store and via the voice interface 40.

Next, at step 82, the current user is presented with a content transmission option voice prompt. Responsively to this prompt, the user selects a transmission method/s or connectivity options for the desired content. The user usually chooses a preferred transmission method presented by the client's transmission option voice prompt, but the content management interface processor 12 may respond to a transmission method requested by the user, but which is not included in the voice prompt. In this case, the content management interface processor 12 and system manager 30 determines if the requested mode is available. Alternatively, the user may be motivated by a content transmission voice prompt to ask verbally for a preferred transmission method. It should be noted that the client's space can be limited by in some transmission or connectivity modes. The content management interface processor 12 may also be assigned telephone numbers differentiating between transmission and connectivity modes or services. Thus, a user may dial a wireless data session phone number or a digital TV session phone number and select the client and content.

Voice transmission option prompts are automatically adjusted according to the selected data transmission methods. The content management interface processor 12 may be preloaded with voice transmission option prompts, which are automatically generated and attached to conversation scenario scripts between the user, the content management interface processor 12 and the client's space, such as dialog scripts relating to content and transmission mode selections.

The user may be asked by an appropriate voice prompt to disclose additional details regarding the selected or default transmission method, connectivity option or user communication device. For example, if the user selected email or facsimile as a preferred return mode, the user would be asked by an adaptive voice prompt, to disclose his email address and facsimile number, respectively.

In some embodiments, once a user has disclosed additional details of a required transmission mode such as his email address, the details are saved in the database 44, so that repetition of the details is not required in the same or subsequent sessions. Alternatively, the user may be issued an identifier by the content management interface processor 12. Thus, the user can be authenticated when input conventionally, or when vocalized by the user, using the voice authentication module 34 in the latter case.

In case of clients configured like the client 20, the content management interface processor 12 may be configured using the assigned content management interface 24 to return the user to the client's main data menu voice prompt script, at which point step 80 can be repeated.

Clients configured like the client 16 can configure their assigned content management interface 24 and memory store 48 to offer wireless (or wire-line) data sessions as a transmission mode. In this case, a user may elect to use only a wireless (or wire-line) data session as a transmission method in step 82. The session is initiated by the content management interface processor 12 and content return module 64, connecting and presenting the user to the chosen data menu voice prompt content area on the client's reserved space on the memory store 48. Alternatively, the wireless data session can be initiated by an actionable alert or directly by the platform, according to connectivity content allotted by the content management interface processor 12 to client's content memory store 48. Multimodal wireless (or wire-line) session or digital television data session as transmission modes can be established in like manner. Thus, if “multimodal” is selected, the user is connected to the client's content memory store 48 in a multimodal data session mode.

The method continues at final step 84. The current user is presented with an exit voice prompt, and the content is delivered or a connectivity option is established according to the option selected in step 82. For example, the user may say “MMS”, or “video”, and the content accordingly begins to stream from the content return module 64 to the user's device. If the user says “Internet” or “Wireless Data Session”, content return module 64 initiates a wireless or wire-line data session according to the data menu connectivity content provided by the client. If the user says “Digital TV” or “Multimodal” content return module 64 initiates the appropriate session according to the data menu connectivity content provided by the client. As noted above, the voice interface 40, is configured by the system manager 30 to be able to react to a variety of user responses in order to deliver desired content.

Content is transmitted or delivered directly to the user's communication device according to the user's network operator or carrier procedures. Usually, the content will be transmitted either using automatic number identification (ANI), DNIS data-dialed number identification service (DNIS, or other number or device identification technology to the user's communication device. Alternatively, some connectivity options and transmission methods involve a communication device or terminal not employed by the user at step 68. For example if the data sessions involve digital TV data session, facsimile or computer. If email is involved, the content may be returned to the user's email account, which can be configured with a computer, PDA or a wireless device.

If a visual data mode was chosen, a voice channel opened by the content management interface processor 12 may continue to support the user's data session, enabling the user to continue to interact with the client or the system 10 during the session. The channel may also be used to monitor the data session for quality assurance purposes. For example, an initiated digital television data session may be supported by the opened voice channel, allowing the user to see the data on its TV terminal and concurrently interact with the client's space.

The session analysis module 50 may record users' sessions and store recorded session data in the database 44. The voice authentication module 34 may identify a user who has initiated a session with the content management interface processor 12 or a client's reserved space, and offer alternatives or perform tasks according to the user's data on the database 44. Stored session data may include, for example, the user's communication device number, ID codes, addresses, numbers, general information, user patterns, frequently accessed client spaces, frequently accessed content, frequently employed transmission methods or connectivity options.

The content management interface processor 12 may interact with the user by adaptive data menu voice prompts, customized according to the stored user session data, regardless of any client-created voice script. For example, once a user is identified by the voice authentication module 34 and the user's email address is stored in the database, the content management interface processor 12 notifies the user by an adaptive voice prompt that the chosen content is being sent to the stored email address. User stored session data may be collected during an actual user-system-client interaction session, or the user may update the database 44 using conventional communication means. For example, the user may send an email to the content management interface processor 12 that directs an update to the database 44. Alternatively, the user may be allowed to enter the database via a dedicated network or terminal connection and configure or update its information. In an alternative embodiment, the user may require information to be sent to a particular communication device by the content return module 64.

The system 10 may allow a user to initiate a content message to a client by selection from a voice prompt, which may be client-created or provided by the content management interface processor 12. The user is then guided by the content management interface processor 12 through a content message procedure. The user vocally records; keypad inserts, or attaches a content message on his communications device. The user-created content message is then sent to the client via the user's vocally selected transmission method, or by a default transmission method associated with the content message procedure, with appropriate format conversion. The content management interface processor 12 converts the user-created message according to the user-selected transmission method. For example, if text transmission is selected for a vocally recorded message, appropriate voice-to-text format conversion will occur. The content message is recorded, using a mailbox system, and stored on the database 44. A client can reach the stored user-created content message using the facilities of the system 10. Alternatively, the content message can be simply stored on the client's reserved space or any other storage medium specified by the client. Any additional information required to send the message may be requested by an adaptive voice prompt of the content management interface processor 12. If a user desires to create a content message using the capabilities of the system 10 addressed to a non-subscriber or addressed to himself, the user will be required by a voice prompt of the content management interface processor 12 to disclose additional information regarding the recipient, such as his address or number to which the content message will be sent.

Client Subscription.

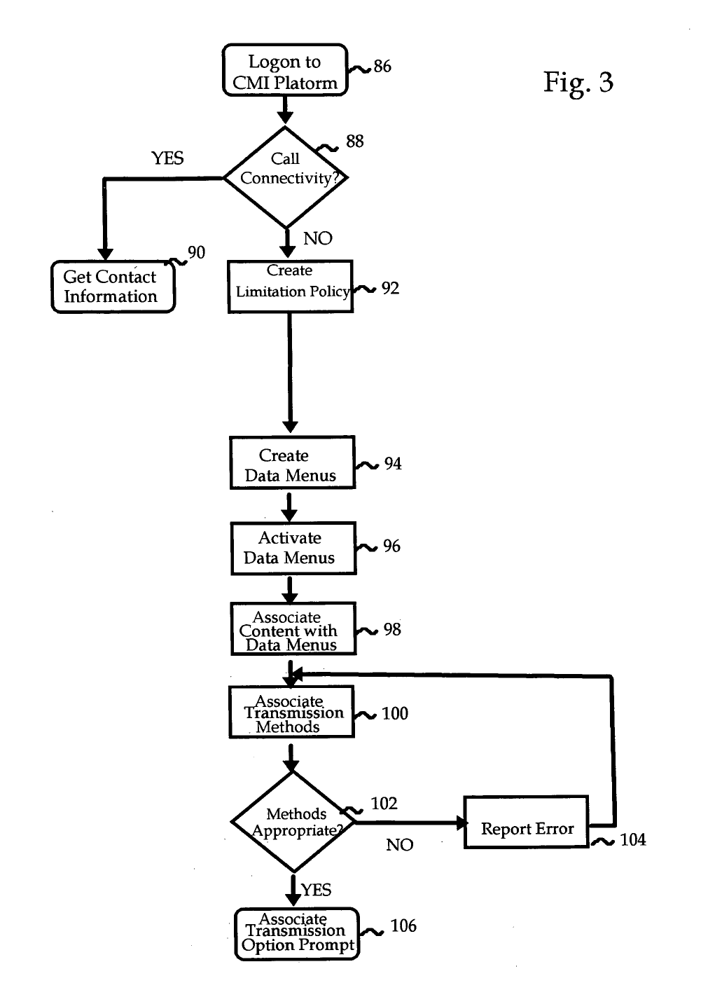

Reference is now made to FIG. 3, which is a flow diagram describing a method of client subscription to the content management interface platform in accordance with a disclosed embodiment of the invention. The method is disclosed with reference to the system 10 (FIG. 1), and begins at initial step 86. A client desiring to subscribe to a content management interface on the content management interface platform initially logs on to the platform, using a telephonic connection using a conventional device such as a modem, or establishes a connection via a data network, for example the Internet. This connection is normally made using a data terminal executing a downloadable program, a web-based computer, or a workstation. A visual functional table, described below, is assigned to the client, upon which various services are presented, managed and operated.

Using its assigned content management interface 24 (FIG. 1), the client identifies itself in response to a system prompt by entering its name or any other descriptor by it wishes to be recognized by inquiring users. Upon preliminary recognition by the content management interface processor 12, the client is assigned its own content management interface 24. At this point, the client can optionally select, using this interface, other identifying words and search terms, which, when verbalized by a user, results in the session described above in the discussion of FIG. 2. Access to the content management interface processor 12 via an assigned content management interface is secure and limited to the subscribing client.

There is no limitation on the number of reserved spaces or content management interfaces that may be assigned to a single client. A client may interconnect or navigate among multiple content management interfaces, and can designate a primary reserved space. A client's content manager 36 may choose the language, tune, accent, pronunciation, voice and phonetics (herein: “space phonetics”) of its dialog script. The system 10 may support different languages and phonetics independently or concurrently, or the system 10 may be implemented according to languages and phonetics. Different client reserved spaces may employ different languages and phonetics.

In the case of clients, such as the client 22, which merely wish to offer users 14 a connection to the client's own call center, customer service, telephone assistance, or the like, it may choose a call connectivity option. Control now proceeds to decision step 88, where it is determined if the call connectivity option has been elected.

If the determination at decision step 88 is affirmative, then control proceeds to final step 90. The client 22 enters the telephone number to which users will be routed. The content management interface processor 12 automatically attaches an appropriate connectivity voice prompt to be announced to users.

If the determination at decision step 88 is negative, then control proceeds to step 92. Using its content management interface 24, the client optionally can register a limitation policy in the limitation module 32 (FIG. 1). If elected, the limitation module 32 is activated, and the platform guides the client's content manager 36 during the policy's configuration. Otherwise, step 92 is omitted. Generally, limitation guidelines relate to the client's reserved space. However, limitation policies may additionally be imposed on data menus, content and transmission methods at the client's discretion. The platform is flexible, and allows the client to extend the domain of limitations that are pre-programmed in the content management interface 24, subject to governing policies of the system manager 30.

If the determination at decision step 88 is negative, then control proceeds to step 94. Here the client creates data menus, user-client vocal interactions and dialog scripts. The data menus and vocal interactions are inserted and created on the assigned content management interface 24. Typically, the data menus are informational voice labels, voice prompts, or vocal scripts to be presented to an inquiring user. Voice prompts may include products, store location, sales fact sheet, and contact number, and many other data menus, according to the client's policy. Each of the data menus represents different content or content areas. These prompts are known as static prompts. A typical example is the voice prompt, “Welcome to ABC. Please choose form data menus A, B, C, D,” or “How can I help you?”. Data menus, user-client vocal interactions and dialog script paths are crated by the content manager 36 and are customized to the client's activities. For example, data menus can reference names, brands, labels, topics, descriptions, directories, content areas, applications, or references to a client's web site or internal database when appropriate. The created data menus and vocal interaction scripts are generally professionally recorded. Alternatively, they may be converted to voice prompts from text via known text-to-speech software, and then presented to the content manager 36 for approval by the content management interface processor 12. Data menu voice prompts and vocal interactions are saved in memory, for example as sound files. However, any suitable method of file storage may be used. The data menus are given suitable identifiers by the client's content manager 36.

Alternatively, the content management interface 24 may offer voice prompt options at each data menu level selected from a list provided by the content management interface processor 12. Once the content manager 36 has completed selecting data menu prompts, the content management interface processor 12 generates an initial data menu sequence prompt script, which greets the user at the entrance to a client's content store space. If the content manager 36 elects to use the data menu prompts offered by the platform, the initial data menu sequence prompt is generated automatically by the content management interface processor 12. It will be recalled that there are several ways to create a data menu, such as the initial data menu sequence prompt script. The content management interface processor 12 may be preloaded with all predictable data menu prompts (voice files). The content management interface processor 12 then establishes the prompts according to the selections by the client's content manager 36. If the client's content manager 36 elects to create his own data menus and vocal interactions, the content management interface processor 12 creates the prompts and dialog scripts either by employing text-to-speech programs, professional recording or a combination thereof. When the content management interface processor 12 encounters an unknown client-created data menu prompt, a signal is be sent to the system manager 30, which enters the new prompt into the database 44. The content management interface processor 12 and the system manager 30 cooperate in like manner when a data menu prompt is changed by the client's content manager 36.

The method now proceeds to step 96. The client's content manager 36 may have created a variety of data menus and vocal interactions in step 94, but has discretion to activate and deactivate any or all of them. The content management interface 24 offers a convenient way to develop, create, save and catalog voice prompts. The client's content manager now determines which data menus to activate, activation conditions, and establishes an order of vocal presentation to the user upon entry into the client's space. It is recommended that careful thought be given to the performance of step 96 by the content manager 36. This step is important from the perspective of marketing and public relations, as the user's initial impression of the client may be formed by exposure to the data menus. The strategy of data menu presentation may differ considerably among clients having different commercial or noncommercial purposes. The client's content manager 36 takes into consideration factors as the frequencies of different inquiries, the desirability of branching to submenus, and recovery from user errors. Optionally, content manager 36 can create an introductory voice message that is announced before and after the data menus.

Next at step 98, content is associated with the data menus that were established in step 96. Content is placed into a designated reserved space by the client's content manager, who must take into account the transmission methods available to return the content to the user. Alternatively, a link is established between the client's internal database and the client's reserved space in the content management interface processor 12. Changes in the content in the client's internal database automatically appear in the client's reserved space, sparing the need to for the client to manually update its content. As a further alternative, the client's memory store 48 on the content management interface processor 12 may be directly linked to its internal database or web site. The content could be, e.g., text, data, attached data files, databases, web servers, applications, functions, appliances, data addresses pictures, images, sound, audio, data links, voice, video and TV files, interactive data connections, identifiers, HTTP files, files associated with any other protocol and method for enabling information or combinations thereof, and could include a link between the content management interface processor 12 and the client's internal database according to the client's policy. The content management interface 24 provides the client's content manager 36 with editing facilities to adjust the content files. For example, if the client's content manager wants to associate video files with the data menus, he can create, play and edit them. Facilities for the creation of images or messages are also available. Using these facilities, the client's content manager has no need to invest in various software programs to edit content files.

Content (substance and length) is placed according to the client's policy on its assigned content management interface 24. A client's reserved space can be configured in advance to support certain clients, content, applications and modules, in which case the content management interface 24 is registered according to the client's policy. For example, a coupon module enabling a client to edit and place digital coupons can be configured and activated by the client. A user requesting a coupon associated with a certain client dials the content management interface processor 12, say a client name and draws the required configured coupon from the client's space.

A client can utilize its content management interface 24, space and the capabilities of the system 10 to activate applications and programs. The applications are activated using the client's chosen transmission or connectivity mode. The applications may be supplied by the content management interface processor 12, and made available on the content management interface 24. Alternatively, the applications may be provided by the client.

In the case of clients configured like the client 20, which offers wireless data session connectivity, once a user verbally selects the data menu associated with the application, the application is enabled on the user's device in a wireless data session mode. The same applies to all clients offering connectivity via their reserved space. The possible applications that may be offered by clients are highly varied.

The client 16 can offer access to an application using its content management interface 24 to present an appropriate data menu. A user accesses the application on the client's memory store 48 by selecting a preferred transmission method, or by a default transmission method. Alternatively, a client's reserved space can be configured by the client to act as an application itself, according to the client's policy.

For example, the client 20 can offer wireless data session connectivity to a commerce application. Once a user enters the client's reserved space, and verbally chooses the data menu associated with an application (“Commerce”), the content return module 64 initiates a wireless data session commerce application.

As a further example, the client 16 may offer a data menu representing a payment application. Once a user enters the client's reserved space, and verbally chooses the data menu associated with application, e.g., “Payment”, he then accesses the application by selecting a preferred transmission method, or by a default transmission method. Once selected, the content return module 64 initiates the application on or from the client's space, using the chosen transmission mode.

In the event that a client chooses to link its database to the content management interface processor 12, such as the client 18 (FIG. 1), a direct physical connectivity option is selected by the client at logon on the assigned content management interface 24. This option offers a cost-effective way to voice-enable the database 46 (FIG. 1). The client is then guided to provide necessary information to configure a reliable and secure connection between its database and the content management interface platform. More specifically, the client provides the content management interface platform with a description of content, which it wants to make available by voice-enabled search. The content management interface processor 12 then builds appropriate search scenarios for that content as described below. All voice search prompts are stored on the content management interface platform, but are accessible by the client's content manager, and can be modified as described below. However, it is preferable that the content management interface processor 12 create the voice search prompts, because it is connected to the content and is well adapted to generate accurate voice search prompts in accordance to the client's content.

In the event that a client chooses to offer unimodal or multimodal wireless (or wire-line) data session connectivity, or digital TV data session connectivity to users, such as the client 20 (FIG. 1), the appropriate connectivity option is selected at logon. The client is then guided to provide necessary information to configure the selected connectivity option. More specifically, the client provides the content management interface with a description of content and data menus, which it wants to make available by the connectivity option and the appropriate connectivity addresses of the content and data menus, such a URL, IP, WML and HTTP link, and any other content address that may be needed for initiating the connectivity option. The client 20 may simply perform step 94 and step 96 to create and activate data menus from which the connectivity session will be initiated. For each data menu created at step 94 and step 96 connectivity addresses and format must be provided, which are then expressed on the client's content store accessed by users. This enables a wireless (or wire-line) data session, for example, to be initiated from a chosen data menu activated by the appropriate connectivity content message. The content management interface processor 12 then builds appropriate voice prompts and electronic network operator connectivity messages; in response to which a wireless (or wire-line) data session or multimodal wireless (or wire-line) session or digital TV data session is established.

In the case of clients configured like the client 16 the content management interface processor 12 attaches necessary connectivity content to the client's reserved space. Each data menu created in step 94 and step 96 includes allotted connectivity content. When selected by a user in step 80 (FIG. 2), appropriate connectivity content initiates the connectivity mode at a chosen content area of the client's reserved space on the memory store 48.

A single client may provide for activation of multiple, single or different transmission and connectivity options and services defined for different client names during a user's session with the client. For example, the client 20 may offer wireless (or wire-line) data session connectivity to a particular content area, and additionally offer multimodal connectivity or transmission for other content areas or applications during the data session. Alternatively, a wireless data session may offer the user a speech-voice channel application to communicate with a live call center of another client, for example the client 22.

It will be recalled that the client 18 does not utilize the system's content memory store 48. If it desires to offer wireless (or wire-line) data session connectivity, multimodal wireless (or wire-line) connectivity or digital TV connectivity, it would need to be configured like the client 20. If it desires to offer the connectivity options as a transmission mode to content on the database 46, it would be reconfigured similar to the client 16.

If necessary, the content management interface processor 12 converts, formats and prepares the content placed or connected on the client's reserved space, so that it is accessible and downloadable by users. The content management interface processor 12 provides any needed protocols and integration layers to support the connectivity options and selected transmission methods.

The client's content manager may elect to add subsidiary data menus to a primary data menu in order to expand the number of options in a manner that is convenient to the user. Each subsidiary data menu is assigned its own content.

The client's content manager may elect to make placed content available in the future, or to limit the duration of its availability. When the conditions of availability are no longer applicable, an appropriately limiting voice prompt is automatically generated.

Next, at step 100 one or more of the transmission methods and connectivity options described, and specified by the client on its content management interface 24 are associated with a data menu or with content that was created and associated in step 96 and step 98. It will be recalled that various options of content transmission methods are offered to the clients 16, 18, 20, 22 and the users 14. Any combination of content transmission and connectivity methods can be employed by the clients according to their governing polices. Different data menus and content can be associated with different transmission and connectivity methods. The amount of data or the file size in the memory reserved for the content must be appropriate to the transmission methods that the user can select. The content management interface 24 may interact with the client's content manager 36 to recommend transmission methods and an appropriate voice prompt. The content manager 36 may be asked to provide a format or configuration for a specified transmission mode. In the event that the client's content manager does not select transmission methods, defaults appropriate to the client data are automatically supplied.

In some cases the client is asked to provide additional information, for example in the case of the client 20, connectivity content must be provided to each created data menu at step 94 and step 96. If a client associates or links an application with its space or the client desires to interconnect its space with other client databases, the client will be required to provide all necessary configuration data in order to enable the system manager 30 and the content management interface processor 12 to establish the connection. Clients 16, 18, and, 20 can configure and implement their content management interface 24 and reserved space as a standalone application. The content manager 36 is guided to provide necessary implementation data, such as a telephone number or data link to be assigned to the client's content management interface 24 that is accessed by users.

In one embodiment, a client's content manager 36 may request a connectivity option, transmission method or service not currently provided its assigned content management interface 24 or on the content management interface processor 12, in which case the system manager 30 is notified and may react according to the client's request. The client requested transmission method or service may become available to all clients or may be limited to the requesting client space.

If voice message or audio was selected by a client as a transmission method for associated text content in step 98, the content management interface processor 12 creates an audio or voice message either by using text-to-speech technology or professional recording, according to the client's policy. The client may upload a ready-made voice file and associate it with the relevant content and data menus.

Once content is associated with the data menus and transmission methods are selected, the content management interface processor 12 formats the content into the chosen transmission mode. For example, if MMS is chosen, the content is formatted into a MMS message ready to be sent to a user. If a data connectivity option or a visual transmission mode is selected, the content and data menus are optimized and formatted to support the visual data session. For example, if a wireless data session is initiated with a client's reserved space (such as the client 16), the client's data menus and content will be visualized by the user according to the wireless data session format. If the system 10 is configured in a visual data mode, the user-system-client interactions are appropriately formatted.

Control now proceeds to decision step 102, where it is determined if the content transmission method selected by the client's content manager is appropriate. For example if voice file were chosen to transmit a picture, an error would be recognized.

If the determination at decision step 102 is negative, then control proceeds to step 104. An error is reported to the client's content manager 36 via the assigned content management interface 24. The report may be detailed, so as to inform the client's content manager 36 of transmission methods that are compatible with the associated content, or to indicate the magnitude of the reduction in file size that would be necessary to retain the current data transmission options. Control then returns to step 100.

If the determination at decision step 102 is affirmative, then control proceeds to final step 106. An appropriate voice transmission option prompt is associated with the data menu or the content according to the transmission methods and connectivity modes that were provided in step 100. This step is normally performed automatically by the content management interface processor 12. Thus, if only SMS were chosen by the client's content manager 36 for a certain data menu or content, an automatic voice prompt offering SMS delivery would be attached to the data menu or content as a conversational scenario script, and announced to the user. If a wireless (or wire-line) data session or multimodal connectivity was chosen, an appropriate voice prompt would notify the user that he is about to be connected to the client's chosen content area of its reserved space in a wireless data session mode. If SMS and voice were chosen by the client, an automatic voice prompt would ask the user to choose between SMS and voice or both. The content management interface processor 12 adaptively creates voice transmission option prompts to be presented to users, according to the client's polices. Additionally or alternatively, the client's content manager may be offered the option to select a voice prompt, which limits the use of a client's reserved space or certain sections thereof or the client's content to a particular communications device or to a particular transmission mode or connectivity mode. For example, a data menu voice prompt announced upon entry into a client's space, may notify the user that the content in the chosen data menu, space or content store, is deliverable by MMS only or by a wireless data session mode only. If this were unsatisfactory to the user, he could exit the current data menu, content or space and would then be presented with an alternate choice of content. Additionally or alternatively, the client's content manager 36 may be offered the option to select a data menu voice prompt or transmission prompt, which motivates users to verbally ask for a preferred transmission method, without offering a specific mode. In response, the speech recognition module 38 and the content return module 64 identify and return the content to the user, if applicable. Voice transmission prompt locations may vary according to the policies of the client and the content management interface processor 12.

In a further example, the content management interface processor 12 would recognize by any suitable caller identification technology, e.g. ANI, DNIS UID, that a user is calling from a fixed telephone line that does not support data transmission, and could override an established data menu voice transmission option prompt, and offer voice messaging as a transmission option, or another transmission method. The content management interface processor 12 may even authorize a content transmission method that was not selected by the client's content manager, when deemed appropriate. The client's content manager may be offered the option to delegate the content transmission method management exclusively to the content management interface processor 12. In one embodiment, the content management interface processor 12 is capable of identifying user devices and determining what transmission methods or connectivity options are to be offered to the users. The content management interface processor 12 may base the offered transmission method option prompt on the user's device features and capabilities. For example, if the content management interface processor 12 identifies a user with mobile MMS capabilities an adaptive transmission voice prompt will offer MMS content transmission to the user. Alternatively, the content management interface processor 12 may base the transmission option voice prompt on the user's stored session pattern data, stored on the database 44 (FIG. 1). Once the user is identified, an adaptive voice prompt offers the user its most frequent or latest chosen transmission methods, as recorded by the session analysis module 50.

The system 10 may be configured with mobile location-based middleware and application module (LBS) to determine the geographical location of a user, according to the user's device features. Once the user enters a client's reserved space, he is offered content relevant to his current location and the client's location. An example of this functionality is presented below in the discussion of Example 6.

If direct physical connectivity option was chosen in step 96, a search tree is constructed for the database 44 (FIG. 1) and appropriate voice search prompts are attached to the tree. Transmission methods are automatically assigned by the content management interface platform. Indeed, even after the client has been subscribed, the content management interface processor 12 continues to evaluate the client's content, and may re-optimize transmission methods, search scenario trees and voice search prompts. Re-optimization can be disabled or overridden by the client's content manager. Notwithstanding any such disabling or overriding, the content management interface platform alerts the client's content manager if inappropriate transmission options are attempted to be put into effect.

A new subscribing client is added to the database 44, which is speech-searchable by users, as described above.

Updates.

Continuing to refer to FIG. 1, once a client has been registered with the system 10, and its content management interface 24, and reserved space have been assigned and configured, the content manager 36 may change the content of data menus and the content associated with the data menus and the selected transmission methods by logging on to the internet web site (or data network) associated with the system 10 and visually accessing the client's assigned content management interface 24. A client's assigned content management interface 24 and reserved space may be updated, by the content manager dialing the number assigned with content management interface processor 12 and verbally interacting with the content management interface processor 12 as described above. Updating and opening the content management interface 24 space may be performed by personnel having authorized access to the system 10, typically a customer relation agent. Generally, changes in the data menus require a new voice recording, or a high quality text-to-speech text conversion, at the option of the content manager 36. For reasons of security, such changes trigger an alert message informing the system manager 30 that a data menu is being changed. Once content is placed or changed, the transmission and connectivity methods must be re-selected.

The update procedures of the client's assigned content management interface 24 and the content management interface processor 12 enable the client's content manager 36 to review changed content changes and test any revised data menus.

When the changes are completed, the client's content manager 36 is asked to confirm his actions. Confirmation activates the changes on the content management interface processor 12, and they are immediately available to the users 14.

Deactivated data menus and deactivated content are saved by the content management interface processor 12, enabling the content manager 36 to roll back the changes that he has instituted. Any deactivated data menus may be reactivated without need to recreate them. Deactivated content can be reactivated and made available to the users 14 once again.

Administrative Services.

Continuing to refer to FIG. 1, the content management interface processor 12 monitors sessions between users and clients. The monitor can detect a failure of voice recognition in the speech recognition module 38, an error in the execution of the data menus, errors in content transmission, and many other hardware and software errors. Such events are logged, and may result in an immediate notification to the system manager 30 or the client, or the taking of necessary action by the system manager on its own initiative. Any global updates to the system 10 or updates that affect all instances of the content management interface 24 are instituted by the system manager 30 and executed so as to update each subscribing client.

The content management interface processor 12 issues activity reports to the clients, which are reported on each client's assigned content management interface 24. These typically include graphs and a statistical analysis of the content usage, by time, and transmission method. The reports are accessible on the content management interface processor 12. Alternatively, the reports can be automatically delivered to the clients by preselected methods, for example electronic delivery via the Internet.

Among the reports provided the clients by content management interface processor 12 is a content manager report, which is intended to assist the content manager 36 to optimally administer resources of the content management interface processor 12 that are under his control. The content manager report contains resource utilization statistics, which are particularly applicable to clients configured like the client 16, in which rented memory space is provided by the system 10. The content manager log includes details as to data menus that were created, activated, and deactivated, data menu order, content requests via different data menus, and the distribution of data menu access by the users 14 and utilized transmission methods. The content manager report also includes a summary of content that was placed on or linked to the client's space on the system 10 by the content manager 36, a report of dated content, and a ranking of content and transmission methods by frequency of access.

Additional Services.

Continuing to refer to FIG. 1, there may be clients desiring to register with the system 10, but not wishing to use its more extensive management facilities. In a limited form of subscription to the system 10, the content management interface processor 12 offers only the client's telephone number or other basic information, and a voice prompt by which the user may select transmission methods to receive additional contact information. SMS is a typical transmission method for this purpose.

A group of additional related services includes callback, “leave or send a message”, and “message board” can be activated according to the client's policy via the assigned content management interface 24. Once a user has entered into a client's reserved space on the system 10, he may be offered, subject to the approval of the content manager 36, a voice prompt offering an option to leave a message with the client, or to enter a request to be called back by the client. The content management interface processor 12 generates and announces an appropriate voice prompt. The message created by the user is transmitted to the client, as a recording, or could be converted into text and then sent to the client. The message may launch an application. Alternatively, the content management interface processor 12 may notify the client that a message requiring its attention has been deposited in the system 10.

It is possible for an individual or other entity to assume the status of a client and a user as to the system 10 for different purposes. When such a dual status entity accesses the content management interface processor 12, it is considered to be a user. When it configures its assigned content management interface 24, it is considered to be a client. In addition to the various above-described reserved space uses, a dual status entity may utilize its reserved space as a “favorites portal” upon which favorite clients, topics and defined content are stored, rapid access to such clients and content being available in multiple selective output modes. Thus, a dual status entity can configure its space with various applications as a client, such as receiving content messages from other clients or users. For example, email or voice mail accounts may be configured in the role of a client, such that messages are received and stored in the reserved space. Using the above described procedures, the dual status entity can select a preferred or default transmission or connectivity methods for the received messages. The messages are converted and made available by the content management interface processor 12 according to these selections. For example, if a dual status entity receives a message and its space is configured to receive to provide messages in a MMS mode, the content management interface processor 12 convert all messages into a MMS format, and send or store it for the entity to read in his user status. Any needed conversions are accomplished as described above. A dual status entity can further utilize its space to send content messages to other individuals, clients or to itself using selected transmission methods.

A client's content management interface 24 on the content management interface processor 12 may function as its message board, onto which content is placed and accessed by authorized personnel. The message board can function as a “push” service, for example to distribute company announcements to employees. Vocal prompts generated by the content management interface processor 12 enable the content manager 36 or other authorized personnel to edit and create messages. As an alternative to sending out large number of electronic messages, a client can obtain a specialized telephone-linked or data-linked content management interface 24 on the content management interface processor 12, which is adapted to the management of a “pull” style message board. Addressed content messages are placed by the content manager 36 on the client's telephone, data-linked space, which can be accessed by the addressees, who connect to the content management interface processor 12 using any of the procedures described hereinabove.

In contrast with known messaging service providers offering “one-to-all” or unified messaging services, the content management interface processor 12 and the content management interface 24 allow unlimited content length, and provides for multiple content transmission and connectivity methods, operated by speech recognition as described above. All the content manager 36 need do is post the message or content on the its assigned content management interface 24, which is then expressed in the client's content store on the content management interface processor 12, select one or more preferred or default transmission or connectivity methods, and log off. The addressee or user then connects with the content management interface processor 12, identifies the client as described, and accesses his messages or content and then selecting a preferred transmission method, or by a default transmission method. Conventional security features, for example passwords, are enforced by the limitation module 32 to prevent unauthorized access to messages or content on the client's reserved space.

Implementation Details.

Referring again to FIG. 1, in an alternate embodiment of the invention, the content management interface processor 12 is loaded with predefined search terms, verbs, data and content to define a database, which is organized using search trees. A prompt specification document is created to describe for all content on the system 10. Typically, multiple paths available to users at some prompts result in a complicated flow chart that graphically describes the conversation flow. The content management interface processor 12 searches the database, and automatically generates data menus, prompts, commands, alerts and set up all required administrative tasks. The content management interface processor 12 reiterates this process when the database is modified. The content management interface processor 12 then automatically attaches the automatically generated data menus and prompts to the related content and conversation scenario and dialog scripts. This process is executed for each applicable client that has subscribed to the system 10. Once a client begins to actively manage its space, the content management interface processor 12 is able to analyze the client's space and generate modified data menu prompts according to changes in content and allocate them into the dialog scripts.

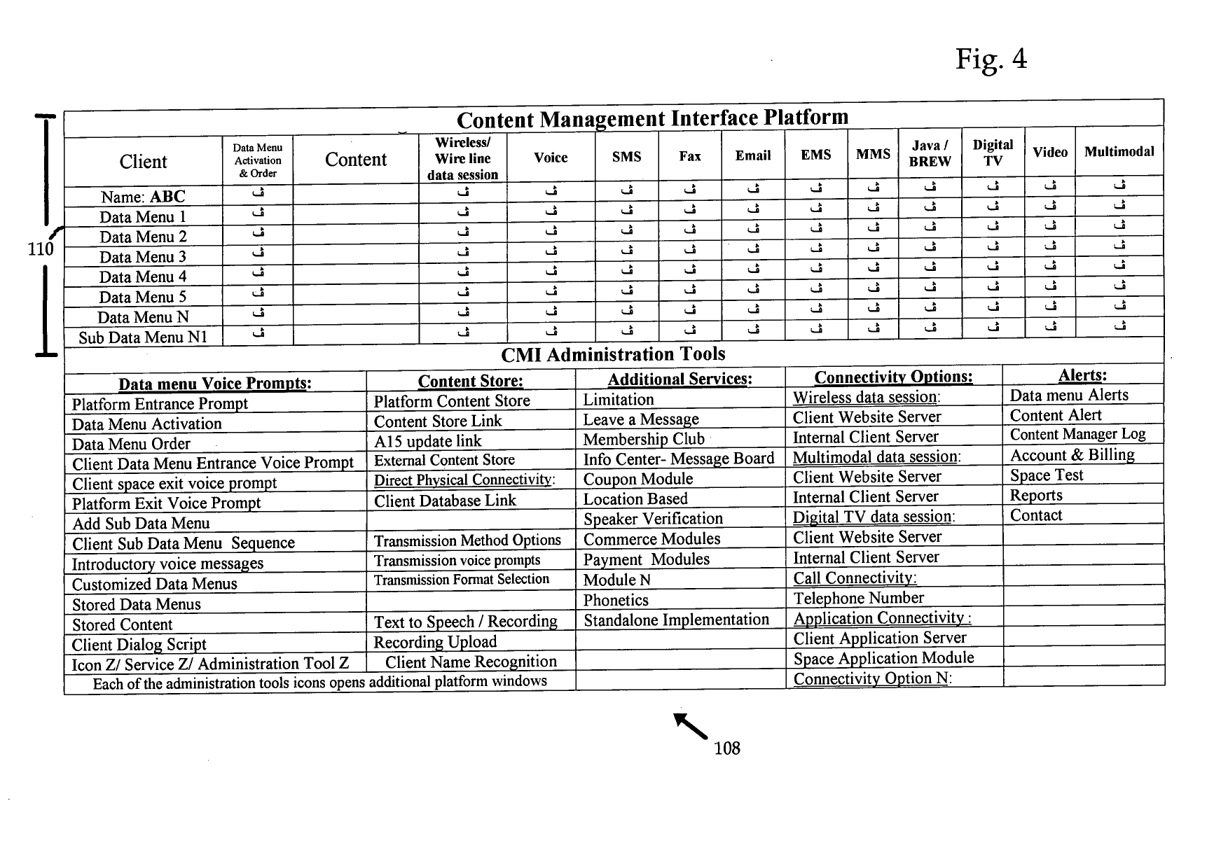

Reference is now made to FIG. 4, which is a functional table 108 of a content management interface platform in accordance with a disclosed embodiment of the invention. The table illustrates maximum functional and administrative support of the client by the content management interface platform. The table also illustrates different options for content return, which can be associated with different requests via data menus. The table 108 has a top section 110, which supports multiple connectivity configurations, as is explained in the following examples.

### EXAMPLE 1

Reference is now made to Table 1, which is a functional table of a content management interface platform in a direct physical connectivity configuration in accordance with a disclosed embodiment of the invention. The client's internal database is linked to the content management interface platform. Database administration functions are generally reserved to the client. The results of the operations shown in Table 1 are entered in the top section 110 of the table 108 (FIG. 4).

TABLE 1
Client connects its database to Content management interface
processor connectivity details

| | | | |
|---|---|---|---|
| Client Provides: | Data menu voice | Selection | Content association |
| preliminary | prompt generation. | of | In case a |
| search tree: all | Content management | Transmission | client desires |
| verbs, content | interface processor | Method of | to implement its |
| description and | generates prompts | content | space as a |
| predicted search | according to the | to a | standalone |
| scenarios and | predicted searches | user. And | application; a |
| paths. Content | and paths. A data link | voice | telephone number |
| management | is estalsihed | prompt | is provided by |
| interface | according to the client | attachment | the client. A |
| processor | provided infimation. | to | user dialing |
| conducts its own | | dialog scripts. | this number will |
| search tree and | | | immediately be |
| establishes all | | | routed to the |
| necessary search | | | client's |
| scenarios according | | | reserved space. |
| to the content in the | | | |
| database. | | | |

### EXAMPLE 2

Reference is now made to Table 2, which is a functional table of a content management interface platform in which only phone connectivity is configured in accordance with a disclosed embodiment of the invention. Minimal services in this configuration are provided by the content management interface platform. The results of the operations shown in Table 2 are entered in the first two rows of the top section 110 of the table 108 (FIG. 4).

TABLE 2
Client wishes to offer users call connectivity to the
Client's contact center

| | | |
|---|---|---|
| Client Provides: | Data menu voice prompt | Selection of |
| Connecting Phone | generation. Content | Transmission |
| Number and any | management interface | Method of content |
| additional | processor generates | to users. Prompt |
| contact | voice prompts according | attachment. |
| information. | to the contact details | |
| | and paths. | |

### EXAMPLE 3

Reference is now made to Table 3, which is a functional table of a content management interface platform in which only wireless (or wire-line) data session connectivity is configured as described above. The table illustrates functional and administrative support of the client by the content management interface under this limited configuration. The results of the operations shown in Table 3 are entered in the top section 110 of the table 108 (FIG. 4).

TABLE 3
Client wishes to offer users wireless (or wire-line) data
session connectivity to its internal database or web server.

| | | | |
|---|---|---|---|
| Client creates | Data menu | Once the user | The wireless |
| data menus representing | voice prompt | verbally | (or wire- |
| content | and connectivity | chooses the | line) data |
| areas on its database. | message | desired data | session is |
| Client | generation. | menu, content | established |
| then provides all | Content | return module | directly by |
| data addresses of | management | will connect | the Content |
| its internal database | interface | and present | management |
| or web | processor | the user directly | interface |
| server-databases, | generates | to the | processor. |
| according to the | voice prompts | chosen data | Or, an actionable |
| created data | sequences to | menu content | link is sent |
| menus. For example, | be presented | area on the | to the user, |
| if web site | to inquiring | client's web | once the |
| connectivity is | users according | server or internal | user OK's |
| desired, client | to the | server | the alert he |
| would provide- | client created | in a wireless | is logged to |
| home page, data | data | (or wire- | the chosen |
| menus, sub data | menus details | line) data | content on |
| menus and sub - | and paths. | session mode, | the web site |
| sub data menus | Should the | according to | or database |
| names, etc., with | client require | the connectivity | in a wireless |
| appropriate data | this | message. | data |
| addresses, e.g. | connectivity | | session |
| URL, IP, HTML, | or transmission | | mode. Alternatively, |
| WML (Connectivity | mode to | | the platform |
| Message). Client | its reserved | | may send the |
| also selects the | content memory | | user's network |
| wireless or wire- | store, | | operator |
| line data session | the platform | | a connectivity |
| format (internet | will allot | | message. |
| browsing, wireless | the connectivity | | |
| TV/Video | message | | |
| session, download | and provide | | |
| or multimedia | session optimization. | | |
| session, messaging | | | |
| and more). | | | |

Table 4 shows a completed example of a session in accordance with the configuration of Table 3.

TABLE 4
Wireless (wire-line) Data Session Connectivity Configuration

| User: dials the telephone number assigned to the content | | |
|---|---|---|
| management interface processor. | | |
| Platform: Hi, please say the name of the client. | | |
| User: user says a client's name-“ABC” | | |
| Platform: [Data menu sequence] Hi, welcome to ABC, please | | |
| select form the following data menus, the content is available | | |
| only in a Wireless/Wire-line Data Session mode. | | |
| Client Name: | Session Format Selection: Mobile internet | |
| ABC | browsing | |
| | | Link-URL/IP/Date Address |
| Data Menus: | | (Connectivity |
| Content Area | Sub Menus: | Content Message) |
| Web site Home- | — | www.abc.com |
| page | | |
| D | | www.abc.com/D |
| E | | www.abc.com/E |
| F | K, L, M | www.abc.com/F/K/L/M |
| G | | www.abc.com/G |
| H | | www.abc.com/H |
| I | O, P, Q | www.abc.com/O/P/Q |

User: Data menu F, M.
Platform: Content return module initiates a wireless data session onto the user's device, at data menus F, M, either from the client's web server, or internal database, according to the client's configuration.

### EXAMPLE 4

Reference is now made to Table 5, which is a functional table of a content management interface platform in which only wireless or wire-line multimodal session connectivity is configured as described above. The table illustrates functional and administrative support of the client by the content management interface if this limited configuration is registered. The results of the operations shown in Table 5 are entered in the top section 110 of the table 108 (FIG. 4).

TABLE 5
Client wishes to offer users Wireless (or wire-line) Multimodal
Session connectivity to its internal database, web server
or applications.

| | | | |
|---|---|---|---|
| Client creates | Data menu | Once the | The wireless |
| data menus representing | voice prompt | user verbally | (or wire-line) |
| content | and connectivity | chooses the | multimodal |
| areas on its database. | message | desired | session is established |
| Client then | generation. | data menu, | directly |
| provides all data | Content | content return | by the |
| addresses of its | management | module | content management |
| internal database | interface | will connect | interface |
| or web server- | processor | the | processor. |
| databases or applications, | generates | user directly | Or, an |
| according | voice | to | actionable |
| to the | prompts sequences | the chosen | link is sent |
| created data | to | data menu | to the user, |
| menus. For example, | be presented | content | once the user |
| if application | to inquiring | area or application | OK's the alert |
| connectivity | users according | on the client's | he is logged |
| is desired, client | to | web | to the chosen |
| would provide-application | the client- | server or | content or application |
| data | created data | internal | on |
| menus, sub data | menus details | server in a | the web site |
| menus and sub - | and | wireless | or database in |
| sub data menus | paths. In | (or wire- | a wireless |
| names, etc., with | the case of | line) multimodal | multimodal |
| appropriate data | client 16 | mode, according | session mode. |
| addresses, e.g. | the platform | to | Alternatively, |
| URL, IP, HTML, WML | allots connectivity | the connectivity | the platform |
| (Connectivity Message). | and provides | message. | may send the |
| Client also | session optimization. | | user's network |
| selects the multimodal | | | operator a |
| data session | | | connectivity |
| format. | | | message. |

Table 6 shows a completed example of a session in accordance with the configuration of Table 5.

TABLE 6
Wireless (wire-line) Multimodal Session Connectivity
Configuration

| ABC | Session Format Selection: | |
|---|---|---|
| Client Name: ABC | Data menu sequence: Hi, welcome to | |
| | ABC, please select form the | |
| | following menus: | |
| | | Link-URL/IP/Date |
| Data Menus: Content Area | Sub Menus: | Address |
| Application Homepage | — | www.abc.com |
| D | | www.abc.com/D |
| E | | www.abc.com/E |
| F | K, L, M | www.abc.com/F/K/L/M |
| G | | www.abc.com/G |
| H | | www.abc.com/H |
| I | O, P, Q | www.abc.com/O/P/Q |
| J | Details | www.abc.com/Contact |

### EXAMPLE 5

Reference is now made to Table 7, which is a functional table of a content management interface platform in which digital television data session content management is configured as described above. The table illustrates functional and administrative support of the client by the content management interface if only digital television data session connectivity is registered. The results of the operations shown in Table 7 are entered in the top section 110 of the table 108 (FIG. 4).

TABLE 7
Client wishes to offer users Digital TV Data Session connectivity
to its internal database, web server or applications.

| | | | |
|---|---|---|---|
| Client creates | Data menu voice | Once the user | The Digital |
| data menus representing | prompt and connectivity | verbally | TV Data Session |
| content | message | chooses the | is established |
| areas on | generation. | desired data | directly |
| its database. | Content | menu, content | by the |
| Client then provides | management interface | return module | platform. Or, |
| all data | processor | connects or | a connectivity |
| addresses of its | generates | presents the | message |
| internal database | voice prompts | user directly | or an |
| or web | sequences to be | to the chosen | actionable |
| server-databases | presented to | data menu | link is sent |
| or applications, | inquiring users | content area | to the TV operator, |
| according to the | according to | or application | once |
| created data | the client created | on the | the TV operator |
| menus. For example | data menus | client's web | processes |
| if internal | details and | server or internal | the message, |
| database connectivity | paths. Should | server | user is presented |
| is desired, | the client require | on the user's | to the |
| client | this connectivity | TV terminal, | chosen content |
| would provide- | or | according to | on the |
| database home | transmission | the connectivity | web site or |
| page, data | mode to its reserved | message | database in a |
| menus, sub data | content | and format. | digital TV |
| menus and sub - | memory store, | | terminal data |
| sub data menus | the platform | | session mode. |
| names and so on, | will allot the | | The connectivity |
| etc., with appropriate | connectivity | | message |
| data | message and | | sent to |
| addresses, e.g. | provide session | | the TV operator |
| URL, IP, HTML, | optimization. | | may contain |
| WML (Connectivity | | | the requested |
| Message). | | | data |
| Client also selects | | | link and user |
| the session | | | location information. |
| format. | | | |

Table 8 shows a completed example of a session in accordance with the configuration of Table 7.

TABLE 8
Digital TV Data Session Connectivity Configuration

| ABC | Session Format Selection: live or recorded | |
|---|---|---|
| | broadcast, data message, digital | |
| | interactive session, etc. | |
| Client Name: ABC | Data menu sequence: Hi, welcome to ABC, | |
| | please select form the following menus: | |
| Data Menus: Content | | Link-URL/IP/ |
| Area | Sub Menus: | Digital/Data Address |
| Data Server | — | www.abc.com/333.12.333 |
| D | | www.abc.com/D |
| E | | www.abc.com/E |
| F | K, L, M | www.abc.com/F/K/L/M |
| G | | www.abc.com/G |
| H | | www.abc.com/H |
| I | O, P, Q | www.abc.com/O/P/Q |
| J | Details | www.abc.com/J/D |

### EXAMPLE 6

Reference is now made to Table 9, which is a functional table of a content management interface platform in which location based content management is configured as described above. The table illustrates functional and administrative support of the client by the content management interface. The client can manage the content management interface processor 12 (FIG. 1) for different client locations. The content manager is guided to provide content for the different client locations. The user is routed to relevant, location based, client content storage space, either by a simple voice-prompt asking for the user's current location. Alternatively, a location-based application (LBS) locates the user's position and offers the user relevant location based content from a client's content store space.

TABLE 9

| Lo- | | | | | | | | | | | |
|---|---|---|---|---|---|---|---|---|---|---|---|
| cation | A | Client enters content relevant to location A | | | | | | | | | |
| Client | C* | W* | V* | SMS | Fax | E* | EMS | MMS | J* | Vi | M* |
| Name: | | | | | | | | | | | |
| ABC | | | | | | | | | | | |
| Data | | | | | | | | | | | |
| Menus | | | | | | | | | | | |
| Content | | | | | | | | | | | |
| Line N | | | | | | | | | | | |
| Content | | | | | | | | | | | |
| Line N1 | | | | | | | | | | | |
| Content | | | | | | | | | | | |
| Line N2 | | | | | | | | | | | |
| Content | | | | | | | | | | | |
| Line N3 | | | | | | | | | | | |
| Content | | | | | | | | | | | |
| Line N4 | | | | | | | | | | | |

Key:
C*—Content
W*—Wireless/Wire-line data session
V*—Voice
E*—Email
J*—Java
Vi—Video
M*—Multimodal

Instances of Table 9 are completed for each client location.

### EXAMPLE 7

The following example illustrates the beginning of a conversation between the system 10 (FIG. 1) and a user. A user-system-client menu interaction is presented in Table 10. The main entrance prompt of the system 10 is shown at line 2. The client's main data menu sequence is shown at line 4. At line 8, the content management interface processor 12 has generated a transmission options prompt and attached it to the content or data menu selected by the user. An exit prompt has been generated by the content management interface processor 12 at line 10.

TABLE 10

| | Expected User Input | System Response |
|---|---|---|
| 1 | User Accesses System | Recognition |
| 2 | Recognized Expected Input | Please say the name of the |
| | | Client. You may also say Main |
| | | Menu, Help. |
| 3 | Caller Says Requested client | System searches for the |
| | | client's space |
| 4 | Recognized Input: “ABC” | Hi, welcome to ABC, please |
| | | say one of the following: |
| | | sales, prices, fact sheet, |
| | | locations, contact. |
| 5 | Expected User Input | “Sales” |
| 6 | Recognized Expected Input: | I understood ‘Sales.’ Is that |
| | “Sales” | correct? |
| 7 | Expected User Input | “Yes” |
| 8 | Recognized Expected Input | How would you like the content |
| | | sent to you? By SMS, |
| | | MMS, voice, wireless data |
| | | session, EMAIL or digital TV? |
| 9 | Expected User Input | “MMS” |
| 10 | Recognized Expected Input | The info will be sent out by |
| | | MMS, Thank you for using |
| | | {system's servicemark}. For |
| | | any additional information |
| | | say “main menu.” |

### EXAMPLE 8

The following example, presented in Table 11, illustrates the initiation of a user-crated content message procedure.

TABLE 11

| | Expected User Input | System Response |
|---|---|---|
| 1 | User Accesses System | Recognition |
| 2 | Recognized Expected Input | Please say the name of the |
| | | Client. You may also say Main |
| | | Menu, Help. |
| 3 | Caller Says Requested client | System searches for the |
| | | client's space |
| 4 | Recognized Input: “Create a | Hi, welcome to “Message Center”, |
| | Content Message” | please say who the recipient |
| | | is: client (subscriber), |
| | | none-client (none- |
| | | subscriber) or myself. |
| 5 | Expected User Input | “None-Client” |
| 6 | Recognized Expected Input: | I understood ‘none-cleint’ Is |
| | “None-Client” | that correct? |
| 7 | Expected User Input | “Yes” |
| 8 | Recognized Expected Input | How would you like the content |
| | | message to be transmitted? |
| | | By SMS, MMS, EMAIL, IM |
| | | or voice recording? |
| 9 | Expected User Input | “EMAIL” |
| 10 | Recognized Expected Input | Please vocally record or insert |
| | | your content message. |
| 11 | Expected User Input | User vocally records a message. |
| 12 | Recognized Expected Input | Message recorded and converted |
| | | to text. Message may |
| | | be sent to user for approval. |
| 13 | Recognized Expected Input | Please provide details of recipient. |
| | | If the recipient is |
| | | a client this step is |
| | | skipped. |
| 14 | Expected User Input | User provides recipient's |
| | | EMAIL address. If the message |
| | | is in the “myself” status, |
| | | message may be sent to user's |
| | | employed communication device. |
| 15 | Recognized Expected Input | Message sent |

### EXAMPLE 9

The following example illustrates the initiation of a visual data transmission or connectivity mode to a chosen content area of the client's reserved space on the content memory store 48, such as that of the client 16. Table 12 illustrates a visual browsing data screen displayed to the user from the client's reserved content memory store 48, the client created data menus and content are presented to the user. The clients 18, 20 may also utilize the memory store 48 when initiating a data session to a remote database.

TABLE 12
Content Memory Store

| Client Name: ABC | Session Format Selection/session optimization | | | |
|---|---|---|---|---|
| | | | | Connectivity - |
| | | Sub | | allotted by the |
| Data Menus: | Content | Menus | Content | platform |
| Client ABC content | | | | www.abc.com/ |
| store homepage | | | | 333.12.333 |
| D | | | | www.abc.com/D |
| E | | | | www.abc.com/E |
| F | | K, | | www.abc.com/F/K/L/ |
| | | L, M | | M |
| G | | | | www.abc.com/G |
| H | | | | www.abc.com/H |
| I | | O, P | | www.abc.com/I/O/P |

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A computer-implemented method of information retrieval, comprising the steps of:
subscribing a plurality of clients to a common server;
for each of said clients, defining a memory for content thereof;
monitoring changes in said content in said memory;
responsively to said changes, automatically generating first voice menus directing a user to said content of one of said clients for selection thereof and second voice menus that prompt said user to vocally select transmission methods for delivery of selected portions of said content to said user, wherein vocal responses of said user to said first voice menus and said second voice menus are automatically recognized by said server; and
initiating said delivery of said selected portions of said content to said user via selected ones of said transmission methods.

2. The computer-implemented method according to claim 1, further comprising the step of selecting a connectivity method for transmission of said selected portions of said content to said user.

3. The computer-implemented method according to claim 1, wherein said user accesses said server using a voice supporting communications device.

4. The computer-implemented method according to claim 1, wherein said memory is located in said server.

5. The computer-implemented method according to claim 1, wherein said memory comprises a database at a location that is remote from said server.

6. The computer-implemented method according to claim 1, further comprising the step of limiting a number of connections between at least a portion of said clients and concurrent users that are accessing said server.

7. The computer-implemented method according to claim 6, further comprising the step of limiting an amount of said content that is available to said user.

8. The computer-implemented method according to claim 1, further comprising the steps of uploading user data from said user via selected ones of said transmission methods and via selected connectivity methods for storage thereof in said memory of at least a portion of said clients.

9. An information management system, comprising:
a common server operative to perform the steps of: subscribing a plurality of clients thereto,
for each of said clients, defining a memory for content thereof;
monitoring changes in said content in said memory;
responsively to said changes, automatically generating first voice menus directing a user to said content of one of said clients for selection thereof and second voice menus that prompt said user to vocally select transmission methods for delivery of selected portions of said content to said user, wherein vocal responses of said user to said first voice menus and said second voice menus are automatically recognized by said server; and
initiating said delivery of said selected portions of said content to said user via selected ones of said transmission methods.

10. The information management system according to claim 9, wherein said server is operative to provide a plurality of connectivity methods that are selectable by said user for transmission of said selected portions of said content to said user.

11. The information management system according to claim 9, wherein said server is operative to provide a plurality of connectivity methods that are selectable by said clients for transmission of said selected portions of said content to said user.

12. The information management system according to claim 9, wherein said server is operative to assign a content management interface to each of said clients for interaction therewith.

13. The information management system according to claim 9, wherein said user accesses said server using a voice supported communications device.

14. The information management system according to claim 9, wherein said memory is located in said server.

15. The information management system according to claim 9, wherein said memory comprises a database at a location that is remote from said server.

16. The information management system according to claim 9, said server being operative to limit a number of connections between at least a portion of said clients and concurrent users that are accessing said server.

17. The information management system according to claim 9, said server being operative to receive uploaded user data from said user via selected ones of said transmission methods and selected connectivity methods for storage thereof in said memory of at least a portion of said clients.

18. A computer software product, including a computer-readable medium in which computer program instructions are stored, which instructions, when read by a computer, cause the computer to perform a method of information retrieval, comprising the steps of:
subscribing a plurality of clients to a common server;
for each of said clients, defining a memory for content thereof;
monitoring changes in said content in said memory;
responsively to said changes, automatically generating first voice menus directing a user to said content of one of said clients for selection thereof and second voice menus that prompt said user to vocally select transmission methods for delivery of selected portions of said content to said user, wherein vocal responses of said user to said first voice menus and said second voice menus are automatically recognized by said server; and
initiating said delivery of said selected portions of said content to said user via selected ones of said transmission methods.

19. The computer software product according to claim 18, wherein said user accesses said server via a voice supported communications device.

20. The computer software product according to claim 18, wherein said memory is located in said server.

21. The computer software product according to claim 18, wherein said memory comprises a database at a location that is remote from said server.

22. The computer software product according to claim 18, wherein said computer is further instructed to perform the step of limiting a number of connections between at least a portion of said clients and concurrent users that are accessing said server.

23. The computer software product according to claim 18, further comprising the steps of uploading user data from said user via selected ones of said transmission methods and selected connectivity methods for storage thereof in said memory of at least a portion of said clients.

24. A computer-implemented method of information retrieval, comprising the steps of:
subscribing a plurality of clients to a common server;
establishing a voice channel between said server and a user;
with said server presenting first voice menus to said user on said channel that prompt said user to specify one of said clients;
with said server interpreting a first vocal answer from said user responsively to said first voice menus so as to identify said one client;
with said server presenting second voice menus to said user on said channel that prompt said user to specify data of said one client;
with said server interpreting a second vocal answer from said user responsively to said second voice menus so as to identify said data;
with said server presenting third voice menus to said user on said channel that prompt said user to specify a mode of transmission of said data to said user;
with said server interpreting a third vocal answer from said user responsively to said third voice menus so as to identify said mode of transmission; and
causing a transfer of said data to said user via said mode of transmission.

25. The computer-implemented method according to claim 24, further comprising the step presenting fourth voice menus to said user to specify a connectivity method for said transfer of said data.

26. The computer-implemented method according to claim 24, wherein at least one of said first voice menus, said second voice menus and said third voice menus are adaptively generated by said server responsively to vocal answers of said user.

27. The computer-implemented method according to claim 24, wherein said data is stored in said server.

28. The computer-implemented method according to claim 24, wherein said data comprises a database at a location that is remote from said server.

29. The computer-implemented method according to claim 24, further comprising the step of limiting said number of connections between at least a portion of said clients and concurrent users that are accessing said server.

30. The computer-implemented method according to claim 24, further comprising the steps of uploading user data from said user via selected transmission methods and via selected connectivity methods for storage thereof in a reserved memory of at least a portion of said clients.

31. A computer software product, including a computer-readable medium in which computer program instructions are stored, which instructions, when read by a computer, cause the computer to perform a method for information retrieval, comprising the steps of:
subscribing a plurality of clients to a common server;
establishing a voice channel between said server and a user;
presenting first voice menus to said user on said channel that prompt said user to specify one of said clients;
interpreting a first vocal answer from said user responsively to said first voice menus so as to identify said one client;
presenting second voice menus to said user on said channel that prompt said user to specify data of said one client;
interpreting a second vocal answer from said user responsively to said second voice menus so as to identify said data;
presenting third voice menus to said user on said channel that prompt said user to specify a mode of transmission of said data to said user;
interpreting a third vocal answer from said user responsively to said third voice menus so as to identify said mode of transmission; and
causing a transfer of said data to said user via said mode of transmission.

32. The computer software product according to claim 31, wherein at least one of said first voice menus, said second voice menus and said third voice menus are adaptively generated by said server responsively to vocal answers of said user.

33. The computer software product according to claim 31, wherein said data is stored in said server.

34. The computer software product according to claim 31, wherein said data comprises a database at a location that is remote from said server.

35. The computer software product according to claim 31, wherein said computer is further instructed to perform the step of limiting said number of connections between at least a portion of said clients and concurrent users that are accessing said server.

36. The computer software product according to claim 31, further comprising the steps of uploading user data from said user via selected transmission methods and via selected connectivity methods for storage thereof in a reserved memory of at least a portion of said clients.

37. An information management system, comprising:
a common server operative to perform the steps of:
subscribing a plurality of clients thereto;
establishing a telephonic voice channel between said server and a user;
presenting first voice menus to said user on said channel that prompt said user to specify one of said clients;
interpreting a first vocal answer from said user responsively to said first voice menus so as to identify said one client;
presenting second voice menus to said user on said channel that prompt said user to specify data of said one client;
interpreting a second vocal answer from said user responsively to said second voice menus so as to identify said data;
presenting third voice menus to said user on said channel that prompt said user to specify a mode of transmission of said data to said user;
interpreting a third vocal answer from said user responsively to said third voice menus so as to identify said mode of transmission; and
causing a transfer of said data to said user via said mode of transmission.

38. The information management system according to claim 37, wherein at least one of said first voice menus, said second voice menus and said third voice menus are adaptively generated by said server responsively to vocal answers of said user.

39. The information management system according to claim 37, wherein said data is stored in said server.

40. The information management system according to claim 37, wherein said data comprises a database at a location that is remote from said server.

41. The information management system according to claim 37, wherein said server is operative to limit said number of connections between at least a portion of said clients and concurrent users that are accessing said server.

42. The information management system according to claim 37, wherein said server is operative to accept uploaded user data from said user via selected transmission methods and selected connectivity methods for storage thereof in a reserved memory of at least a portion of said clients.
